(19) United States
(12) Patent Application Publication
(10) Pub. No.: US 2002/0091603 A1
(43) Pub. Date: Jul. 11, 2002

(54) Payment instrument printing and processing method and apparatus

(76) Inventors: Billy Joe Steiger JR., Ovilla, TX (US); Dorilyn Sletten, Maple Grove, MN (US); Richard S. Aarons, Plymouth, MN (US)

Correspondence Address: Stuart R. Hemphill, DORSEY & WHITNEY LLP, Suite 1500, 50 South Sixth Street, Minneapolis, MN, 55402-1498, US

(21) Appl. No.: 10/011,695

(22) Filed: Dec. 7, 2001

Related U.S. Application Data
(60) Provisional application No. 60/254,252, filed on Dec. 8, 2000.

(51) Int. Cl. G06F 17/60

(52) U.S. Cl. 705/35

(57) ABSTRACT

A system used by a transaction processing company/issuer charges a trustee for payment instruments prepared from a sequence of blank payment instruments that the issuer physically delivers to the trustee for use to sell and issue money orders. The system also permits the issuer and trustee to fulfill a money transfer payout transaction, by using the same blank payment instrument stock for printing of a proper payment instrument and providing a controlled and documented shift of responsibility for individual instruments in the sequence of instruments during a mix of money order sales and money transfer payout transactions.

### PRIOR HISTORY

This application claims priority from U.S. Provisional Application No. 60/254,252 filed on Dec. 8, 2000, the contents of which are hereby incorporated by reference in its entirety.

### TECHNICAL FIELD

The present invention generally relates to payment instrument printing and processing methods and systems. More particularly, the present invention generally relates to methods for printing and dispensing different types of magnetic ink character recognition (“MICR”) encoded payment instruments processable through the banking system, such as money transfer payment instruments for money transfers, money orders, gift certificates, payroll or other checks and the like, on a single secure printer operated by a trustee.

### BACKGROUND

Large retail chains wish to increase customer services at their many locations by offering convenient financial services, such as money order purchases, gift certificates and money transfers. Many retail establishments, such as grocery stores, convenience stores and financial centers, find that they can increase customer flow by offering money orders for sale and money transfer services. Both services, however, require the involvement of a well-known and financially secure entity to insure that the resulting money orders are universally accepted and to provide a large number of outlets from which a money transfer recipient can receive the transferred funds.

Conventional money order transactions involve a customer, a trustee, and an issuer. In a typical transaction, the customer is an individual seeking to purchase a money order. The trustee is the operator of a retail establishment from which the customer physically receives the money order. The issuer is the large, well-known company that is financially responsible for the bank account from which the money orders are paid.

To project its money order services to a larger number of trustee locations, not under its control and not always having their own reliable financial controls or the resources for major financial responsibility, the issuer needs to establish security systems. Because the money orders are, in effect, blank checks drawable on its account, the issuer needs to establish accountability for each such document. This is typically done by supplying a trustee with a limited stock of preprinted, serial-numbered forms, i.e., blank stock ready for completion as “live” payment instruments. These are printed on the customary special security paper as used for checks and money orders and have blanks for insertion of specific transaction information. By contract with the issuer, the trustee becomes chargeable for the money orders printed on this stock.

To enable typical money order transactions, the issuer would first print a defined sequence of blank money order forms and then physically deliver blank stock containing the defined sequence of blank money order forms to the trustee. The issuer would then give the trustee authority both to fill in the amount of each money order in the blank stock and to issue each money order, thus creating a payment instrument, payable in a specific amount and widely accepted. By this grant of authority, the issuer agrees to honor all such instruments properly physically issued by the trustee. The trustee, in turn, contractually agrees to be charged by the issuer for all of the money orders prepared from the money order blank stock.

The customer in this typical money order transaction would approach a trustee location and request a money order for a particular amount (“requested amount”). The customer would then give the trustee employee an amount of cash equal to the requested amount plus the agreed service fee. After receiving the cash, the trustee employee would enter the requested amount on the amount line of a money order form from blank stock and physically issue the completed money order to the customer. After receiving the money order, the customer would eventually use it to pay a vendor, bank, or the like (“third party”). Through the banking system, the third party would present the money order to the issuer's bank and the issuer's bank would (via the banking system) credit the third party with an equivalent amount of funds. The issuer bills the trustee for the amount of the money order as reported by the trustee. Absent fraud or other problems, the issuer collects from the trustee money collected from purchasers corresponding to each money order on which the issuer must pay. Both the issuer and the trustee earn fees paid by the money order purchasers. Problems can, of course, arise if any money order in the sequence of blank stock becomes disputed as to the amount or the fact of issuance by the trustee. Careful physical control over the blank stock, including secure printers for holding the blank stock and means for determining irregularities in printing, are used to deter problems.

This issuer-trustee arrangement is desirable, because it allows even the small, relatively unknown trustees to provide their customers with universally accepted negotiable instruments. However, it is important to note that the trustee in the conventional systems is chargeable almost without exception for each of the blank stock money order forms it receives. That is, although the money order issued is drawable upon the issuer's bank account and the issuer will honor the instrument, the trustee remains contractually chargeable for the amount of all the money orders. This arrangement generally comports with the parties' expectations, because the trustee has physical control of the blank stock of money order forms and operates the printer, and because the trustee should always receive the correct amount of cash from the customer. To assist in management and control over the money order transactions occurring at a trustee, the issuer may use remote data collection means to gather stored data reflecting the trustee/customer money order transactions. For example, U.S. Pat. Nos. 5,647,677 and 5,667,315 show, respectively, arrangements for polling a remote money order dispenser and for coupling a host computer to a money order dispenser at selectable, predetermined times to gather transaction data. The issuer needs to have both reasonable management controls and a high level of trust that its trustees will pay for a sequence of money order sales that matches the issuer's payouts on that same sequence.

Money transfer transactions are increasingly important and can also involve an issuer-trustee relationship. Conventional money transfer transactions involve a send customer (“sender”), a receive customer (“recipient”), a send transaction trustee (“STT”), a receive transaction trustee (“RTT”), and a transaction processing company (“TPC”). In a typical transaction, the sender and the recipient are both individuals. The STT and the RTT are usually both retail businesses, such as a convenience store or grocery store. The TPC is a large, established company that has contractual relationships with a large number of STT's and RTT's with operations in a large number of locations.

The payout of a money transfer transaction is at an RTT and can occur in three general ways:

1. The recipient gets one or more drafts with the recipient named as payee, and the drafts(s) cover the entire amount to be paid out.

2. The recipient gets one or more drafts with the recipient named as payee and also cash, all of which together cover the amount to be paid out.

3. The recipient gets a cash payment of the entire amount to be paid out.

Approaches one and two require drafts with the recipient shown as payee. When an RTT pays out cash directly, as in approach three, it needs to have a balancing transaction.

To enable the drafts needed for money transfer payouts, the TPC handling money transfer transactions would first print a defined sequence of blank payment instrument forms and then physically deliver that blank stock to a trustee that may serve as an RTT. The TPC would then give the trustee authority both to fill in the payment instrument's amount as full or part payment of a money transfer and to issue each payment instrument as a draft payable to the money transfer recipient. By this grant of authority, the TPC agrees to honor such payment instruments physically issued by the trustee.

The sender in a money transfer transaction first approaches an STT location and requests to send a particular amount of cash (“transfer amount”) to the recipient. The sender would then give the STT employee enough information to identify the recipient and pay to the STT an amount of cash equal to the requested amount plus the agreed service fee. After receiving the cash, the STT location would communicate the recipient's identity and the transfer amount to the TPC. Eventually, the sender would contact the recipient to tell him or her of the transfer and perhaps also an RTT location. The TPC would charge the STT for the transfer amount plus the TPC's service fee.

The recipient in this transaction would approach an RTT associated with the TPC and request to receive the transfer amount. Next, the RTT would then contact the TPC, and then request some form of identification. If the TPC approves the payout transaction, the RTT would write out a draft payable to the recipient, allow the recipient to indorse the draft, and give the recipient an amount of cash, up to the maximum cash payout. The RTT could also use the blank stock to issue one or more drafts payable to the recipient and drawable upon the TPC's bank account.

Unlike the trustee relationship in conventional money order transactions, however, the TPC remains primarily responsible for the payment instruments prepared from the blank stock in the RTT's possession and used for money transfer payouts. That is, although the RTT physically may give the payment instrument to the recipient, absent fraud or some irregularity, the RTT is not liable to the TPC for that instrument in the same manner as for a money order sold to a customer. This arrangement also comports with the parties' expectations, because the RTT does receive any cash from its “customer,” the recipient. It is also important to note that this system requires prompt transaction reporting to the TPC from the STT, so that the transaction amount is quickly available to the recipient, and from the RTT, to prevent the recipient from fraudulently requesting the transfer amount more than once, from different RTT's.

Although the same entities frequently serve as “trustees” for money order sales transactions and as RTT' s for money transfer transactions, the differing charging rules and responsibility arrangements for these transaction types has in the past necessitated separate supplies of payment instruments. That is, although the same trustee retail location frequently conducts both money order sales and money transfer payout transactions using payment instruments drawable upon the same issuer, conventional systems require two separate blank stocks of sequenced, payment instruments. One sequence of payment instruments is used for money order sales transactions, which are chargeable to the trustee. The other sequence is used for money transfer payout transactions and, absent irregularities, is not chargeable to the trustee by the TPC.

This dual blank stock problem is magnified because most issuers/TPC's desire the use of secure printers. That is, because these transactions require that the issuer/TPC widely distribute blank stocks of payment instruments on which the issuer is liable under standard negotiable instruments laws, most issuers/TPC's desire that the trustees keep the blank stock in a secure place. This need, in turn, can require the use of two secure printers, which leads to additional drawbacks. For example, two secure printers require more counter space, which is at a premium in most retail stores or other retail locations. Multiple secure printers also increase the issuer's cost of developing a wide network of trustees, which is particularly important for the money transfer payout transactions.

While MICR laser printers are capable of the required printing, dot-matrix printers are widely in use and are sufficient and more cost effective, when the blank stock is pre-printed with required MICR data. In addition, for establishments with a dot-matrix printer already installed and used for money-order sales, it would be advantageous to be able to use that same platform for money transfer payout transactions, i.e., to expand services without an additional equipment investment.

Accordingly, there is a need for a method and system that can process money order sales transactions and money transfer payout transactions without requiring separate secure printing systems and separate blank payment instrument stock at the trustee locations. Such a method and system must conform to the parties' traditional expectations regarding charges made to the trustee and other financial responsibility and still maintain a high degree of physical security. In order to accommodate the expansion of ever wider networks of trustees, it is also desirable for such a method and system to permit efficient and unambiguous accounting for all payment instruments and associated transactions.

### SUMMARY

The present invention provides a method and system that can process money order transactions and money transfer payout transactions on a single secure printer using a single blank stock of payment instruments. One aspect of the present invention is a method for printing and dispensing from a single secure printer operated by a trustee both money transfer payment instruments for money transfer transactions handled by an issuer and other payment instruments for which the issuer will charge the trustee. The method involves providing a single blank stock of payment instruments for the secure printer and providing an issuer data processing system for tracking a plurality of money transfer transactions handled by the issuer and obligations chargeable by the issuer by the trustee. The method further involves the steps of:

receiving at the secure printer printing instructions for money transfer payment instruments and other payment instruments;

in response to printing instructions for a payment instrument for which an issuer will charge the trustee, causing the secure printer to print from the single blank stock a payment instrument with the issuer as drawer and recording the payment instrument in the issuer data processing system as chargeable to the trustee; and

in response to printing instructions for a money transfer payment on a corresponding money transfer transaction, causing the secure printer to print from the single blank stock a money transfer payment instrument with the issuer as drawer and recording the instrument in the issuer data processing system as an obligation of issuer.

### BRIEF DESCRIPTION OF THE DRAWINGS

FIG. 1 is a schematic block diagram of one embodiment of the present invention.

FIGS. 2a-2c show three payment instruments in a sequence of blank stock used for a mix of transactions.

FIG. 3 shows a front side of a sample payment instrument, as printed for a money order transaction.

FIG. 4 shows a front side of a sample payment instrument, as printed for a money transfer transaction, showing an alphanumeric code to indicate that the instrument is intended for cashing by the trustee.

FIG. 5 shows a front side of a sample payment instrument, as printed for a money transfer transaction, showing an alphanumeric code to indicate that the instrument is intended for retention by the recipient customer.

### DETAILED DESCRIPTION

A. Overview

The present method and system works within the conventional assumption that the transaction processing company/issuer will charge a trustee for payment instruments prepared from a sequence of blank payment instruments that an issuer physically delivers (or otherwise provides or arranges to provide) to a trustee for use to sell and issue money orders. However, the method and system permit the issuer and trustee also to fulfill a money transfer payout or receive transaction, using the same blank payment instrument stock. This is accomplished within the sequence of blank payment instruments by use of a transaction processing method and system that permits printing of a proper payment instrument and a controlled and documented shift of responsibility for individual instruments in the sequence during a mix of money order sales and money transfer payout transactions. A data processing system operated by or for the issuer, including a database and various computer code components (software or firmware) is used to document and account for the transactions and determine whether or not the trustee will be chargeable for the value of a financial instrument it dispenses. It is roughly analogous to a bank providing an individual with a single checkbook that can be used both for writing checks that will be chargeable against the individual's account and checks for which the individual will not be charged, because they are issued on behalf of another responsible party, such as the bank.

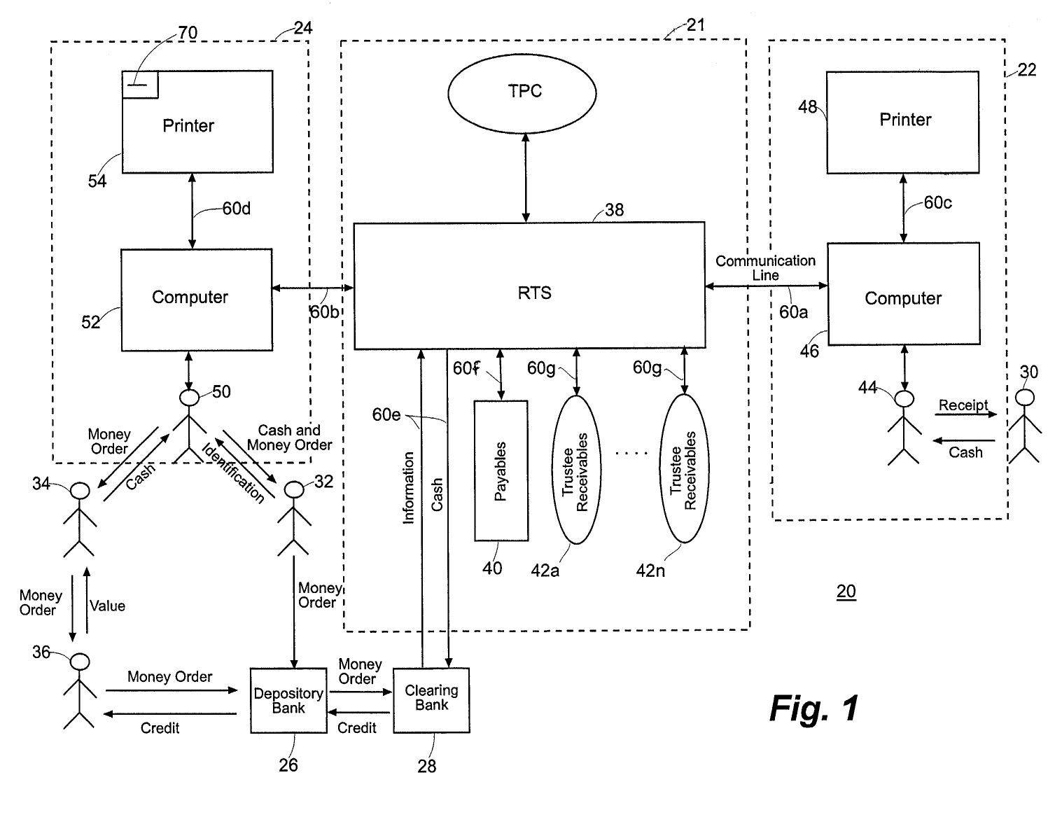

As used herein, “payment instrument” refers to a document that can be issued as a money order sold to a customer, a gift certificate, a payroll or other check, a money order for a trustee payment to a vendor, a money order for trustee reimbursement, or for other similar uses, where the amount of the instrument is paid by the drawer of the instrument, who is also the issuer. The payment instrument is collectible and paid through banking channels much like a check, e.g., a personal check handled by clearing procedures for checks and similar instruments involving the Federal Reserve System and participating banks. FIG. 1 is a schematic view of one transaction processing system 20 embodying the present invention. This embodiment comprises a TPC (or issuer) data processing system 21, at least one STT system 22, at least one RTT system 24, a depository bank 26, and a clearing bank 28 that pays on the payment instruments drawn by the TPC. (The depository bank 26 and the clearing 28 may in some cases be the same bank.) FIG. 1 also shows a send customer 30, a recipient customer 32, a money order customer 34 and a money order payee 36. The TPC system 21 comprises a retail transaction server (“RTS”) 38, that accesses a database having a payables account file 40 (which tracks funds the TPC must pay out on payment on instruments or to trustees who have provided services but have not received customer funds), and a plurality of trustee receivable accounts 42a, . . . 42n (which track funds each trustee owes the TPC). The database may be in any form of electronic or digital memory for data storage configured with various data structures and data files suitable for efficient storage and retrieval. For example, the data structure may comprise a first file for tracking a stock of blank payment instruments to be drawn against an issuer account, with individual instrument identification; a second file for tracking a plurality of payment instrument purchases, said file including:

the amount of each payment instrument dispensed,

an indicator of whether or not said dispensed payment instrument has been presented for payment by issuer,

the amount of funds the trustee dispensing the dispensed payment instrument has been charged for such payment instrument;

and the amount of fees associated with the dispensing of said instrument; and

a third file for tracking a plurality of money transfer transactions, said file including for each money transfer transaction:

identifying information for the recipient of the money transfer,

the amount of money to be transferred,

an indicator of whether or not a payment instrument or other form of payment has been dispensed to the recipient, and

if a payment instrument has been dispensed to the recipient, the individual instrument identification for such payment instrument and an indicator that the issuing trustee is not chargeable for the amount of the payment instrument.

The STT system 22 is staffed by an employee 44, and normally comprises a computer or transaction terminal 46 with a display device (not shown). The computer 46 may have an associated secure printer 48, but would not need one if it handled only voice authorized transactions. The RTT system 24 similarly is operated by an employee 50 and comprises a computer or transaction terminal 52 with an associated, single, secure printer 54. For simplicity, FIG. 1 shows only one STT system 22 and one RTT system 24, although a system 20 would normally have many. Secure printer 54 has storage for blank payment instrument stock 70 within its security enclosure and may have a printer controller or other control circuitry. to receive or process printing instructions.

This TPC system 20 also includes a plurality of communication links 60a-60g that allow various components of the system 20 to communicate with each other, as follows:

a. communication link 60a connects STT computer 46 to RTS 38;

b. communication link 60b connects RTT computer 52 to RTS 38;

c. communication link 60c connects STT computer 46 to STT printer 48;

d. communication link 60d connects RTT computer 52 to RTT printer 54;

e. communication link 60e connects the clearing bank 28 to RTS 38;

f. communication link 60f connects RTS 38 to payables account file 40, which may be on a local storage device or a storage device that is remotely located and shared with other systems; and

g. communication link 60g connects RTS 38 to one or more trustee receivables account files t 42a, . . . 42n, which may be on a local storage device or a storage device that is remotely located and shared with other systems.

The single secure printer 54 holds within it blank payment instrument stock 70, comprising a predefined sequence of payment instrument forms. These payment instruments are suitable for a variety of uses, as noted above. The focus of this discussion, however, will be on two principal uses, money orders (chargeable to trustee) and money transfer payment instruments for money transfer payouts (not chargeable to trustee).

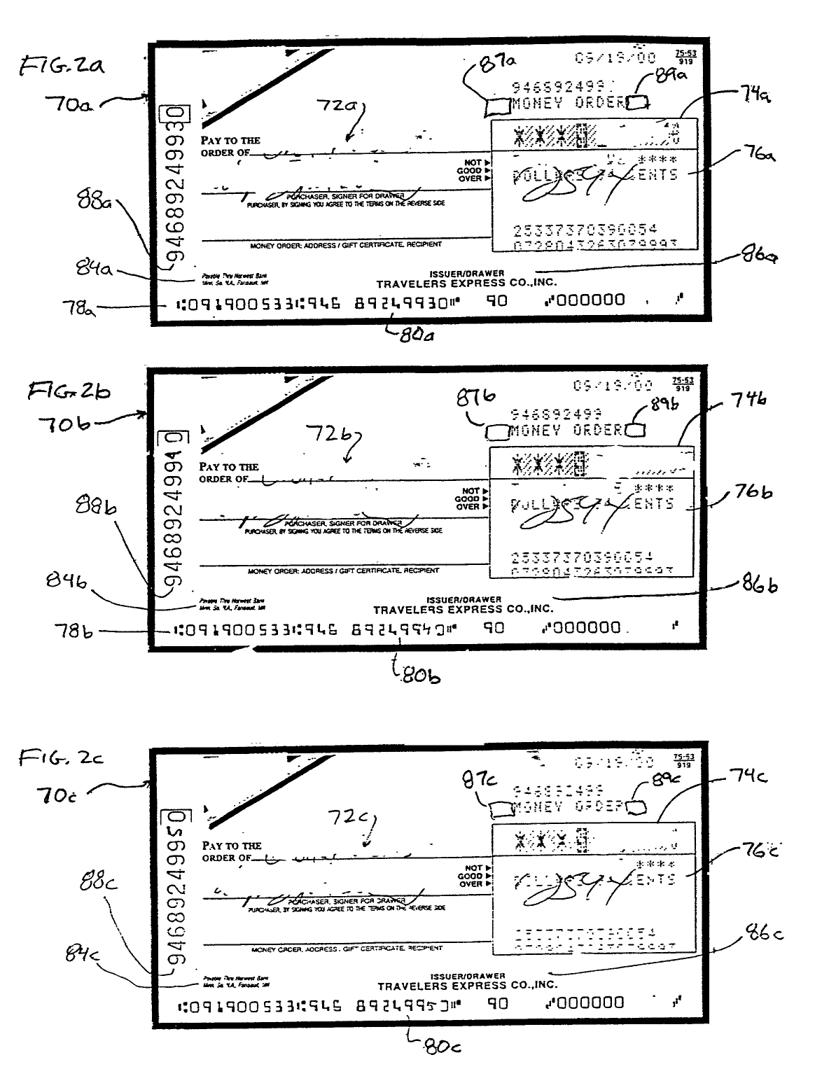

FIGS. 2a- 2c show a short example sequence of three payment instruments 70a-70c (for purposes of clarity, the sub-identifiers “a”-“c” will be not be included unless necessary). For purposes of simplicity of discussion, these three instruments will be treated as the blank stock 70 for printer 54 at some point in time. (In reality, the blank stock at any one time would more likely consist of several hundred instruments to avoid frequent reloading of the printer 54.) Each payment instrument includes a blank payee field 72, a blank numerical amount field 74, a blank written amount field 76, a routing number field 78, an account number field 80, a pair of use indicia fields 87, 89, a clearing bank identification field 84, an issuer/drawer identification field 86, and at least one preprinted serial number field 88 (serving as individual instrument identification, which might also be served by a unique code, pattern, or other indicia).

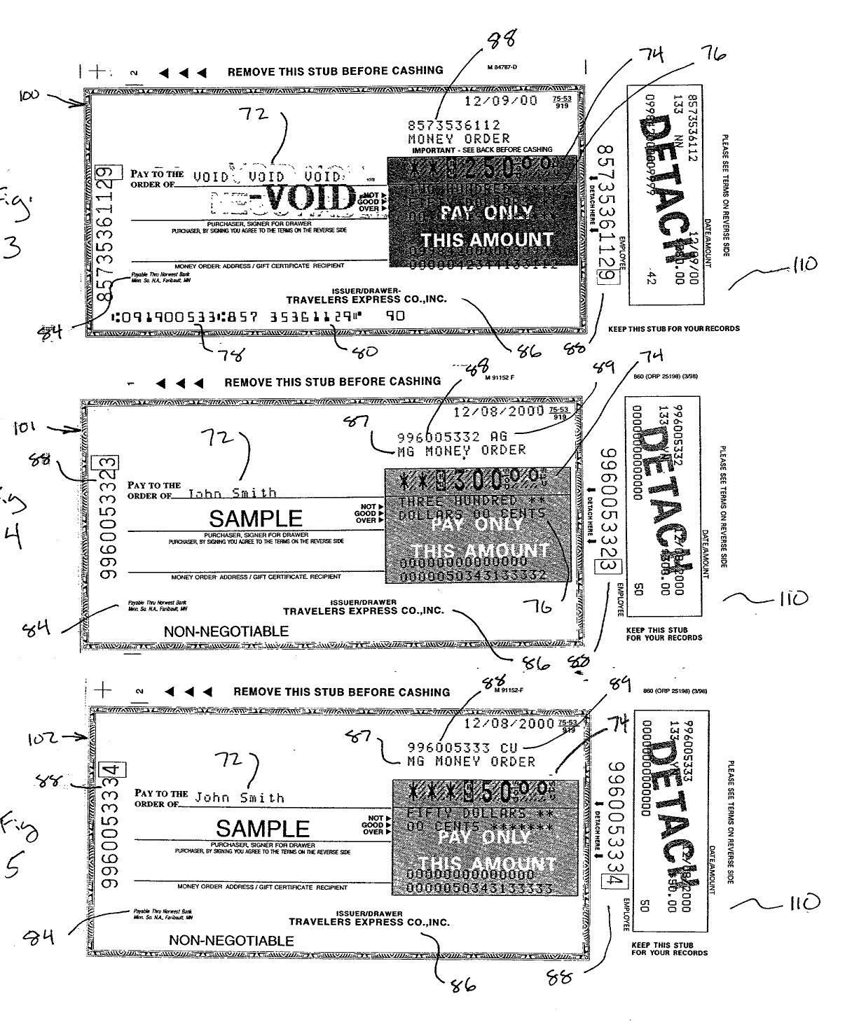

FIGS. 3-5 show three sample payment instruments 100, 101, 102. As will be described in more detail below, instrument 100 is a payment instrument as printed for a money order purchase transaction. Instrument 101 is a payment instrument as printed for immediate cashing by the RTT 24. Instrument 102 is a payment instrument as printed to be retained by the receive customer 32. Each payment instrument 100, 101, 102 includes a blank payee field 72, a blank numerical amount field 74, a blank written amount field 76, a clearing bank identification field 84, an issuer/drawer identification field 86, and at least one preprinted serial number field 88 (again serving as individual instrument identification, which might also be served by a unique code, pattern, or other indicia). Each payment instrument 100, 101, 102 also includes a detachable payment stub 110, which may be retained by the receive customer 32 as a transaction receipt. Instrument 100 further includes a routing number field 78 and an account number field 80. Instrument 101 and instrument 102 further include a pair of use indicia fields 87, 89.

For simplicity in further explanation, we will assume that RTT system 24 will handle both money order sales and money orders issued for the receive side of money transfer transactions, while STT system 22 will handle only the send side of money transfer transactions. In operation, the TPC that operates TPC system 21 would first physically deliver blank stock 70 containing a predefined sequence of documents (blank payment instruments) to the RTT operating RTT system 24. As will be discussed in more detail below, this blank stock 70 will usually be preprinted to include all necessary information in the routing number field 78, the account number field 80, the issuer/drawer identification field 86 (identifying the TPC), and the clearing bank identification field 84 for the Federal Reserve Bank system to debit the amount of a valid instrument against the clearing bank 28. The payee field 72, the numerical amount field 74, the written amount field 76, and the use indicia fields 87, 89 will contain no information at the time the blank stock 70 is to be loaded into secure printer 54.

The RTT that operates RTT system 24 would then insert the blank stock 70 into the secure printer 54. The range of serial numbers for the payment instruments included in the blank stock 70 is entered into the RTT system 24 by “swiping” a coded card included with the blank stock 70, by manual entry of the first and last serial numbers at a keyboard, or similar input means. The TPC that operates TPC system 21 would have given the RTT that operates RTT system 24 authority both to fill in the numerical amount field 74 and the written amount field 76, and to issue each completed payment instrument as a money order sold to a money order purchaser (or other customer purchasing a payment instrument). By this grant of authority, the TPC that operates TPC system 21 agrees to honor completed money orders properly issued by employees 50 of the RTT that operates RTT system 24.

B. Money Order Sale

In a money order sale transaction performed according to this embodiment, a customer 34 would first approach the employee 50 and request a money order for a particular requested amount. The employee 50 would then enter the requested amount into the computer (or transaction terminal) 52. The computer 52 determines whether the amount is to be satisfied in one money order or two (in some cases, three or more). A customer transaction fee is determined and the employee must collect the appropriate amount of money from the customer 34, i.e., the purchased money order amount and the customer transaction fee. The computer (or transaction terminal) 52 has then the information needed to control the secure printer 54. After computer 52 checks to confirm that the secure printer 54 is connected and has blank stock of payment instruments loaded and ready, secure printer 54 receives instructions as to the money order(s) to be printed using the blank stock 70. The computer 52 monitors the printing and is capable of detecting certain irregularities.

With reference to FIGS. 2a-2c, assuming a single money order is to be printed and payment instrument 70a is the top of the blank stock 70, printing proceeds by filling in the amount fields 74a, 76a to create a money order. As an optional precaution, the serial number as tracked by the RTT system may be printed on the money order above the amount fields 74a, 76a, to allow comparison with the preprinted serial number in field 88a. Various other fields may also be printed (e.g., date, serial number, a control number) may also be printed as required. No information appears in the payee field 72a, because this is filled in by the money order purchaser. After being completely and properly printed, the money order 70a is dispensed by the secure printer 54. The employee 50 will then hand the money order 70a to the customer 34, who will complete the payee field 72a.

Assuming the money order is printed per instructions, the serial number used, money order amount and other relevant details comprising a transaction information record are stored in computer 52 and eventually communicated to RTS 38. The RTS 38 will record this transaction information in the database with applicable information in the particular receivables account file 42a, . . . 42n corresponding to that particular RTT that operates RTT system 24. That is, the RTS accounts for this transaction with a credit representing the value of the payment instrument and fees that should be paid to the issuer for handling the money order through its account. The RTT can then be charged for the amount of the money order 70a and the wholesale transaction fee.

Eventually, the customer 34 in this transaction will provide the money order to a payee 36, who will deposit it in a depository bank 26. The depository bank 26, using the Federal Reserve System, will present the money order to the clearing bank 28. The clearing bank 28 will debit the TPC's settlement account (most likely in some aggregate debit that includes a batch of payment instruments payable by the TPC, which debit the TPC will cover with a wire transfer or other payment to its settlement account). The TPC system 21 will capture or receive data communicating the money order's serial number 88a to associate that particular money order 70a with the RTT that operates the RTT system 24 that issued it. This permits the TPC to use its database, including a file for tracking a stock of blank payment instruments provided to the RTT, to reconcile payment on that money order 70a with the amount recorded in the receivables account file 42a . . . 42n associated with the RTT. It will be recognized that instead of a money order, a gift certificate or other similar purchased payment instrument could be printed for a customer and processed in a similar way. All can be tracked in the database in a file for tracking payment instrument purchases.

C. Money Transfer Payout

In a money transfer payout/receive transaction performed using the depicted embodiment of the present invention as the next transaction following the preceding money order purchase, the send customer 30 would first tell the STT's employee 44 the particular amount of funds (“transfer amount”) to be transferred and the identity of recipient 32. The employee 44 will enter this information into the computer 46, which will forward the transaction information to the RTS 38 via the communication link 60a. The RTS 38 will store the transfer amount, the transaction reference number, and the recipient's identity in an accounts payable file 40, and transmit the appropriate service fee amount to the computer 46. The computer 46, in turn, will display this transaction information so that the employee 44 can collect the appropriate amount of cash (or other form of payment) from the send customer 30. Eventually, the TPC operating TPC system 21 will bill the STT operating STT system 22 for the transaction amount and TPC's service fee.

Sometime after the send side transaction is completed, the recipient customer 32 would approach the RTT employee 50 and provide his or her name. The RTT system 24 then begins the sequence of actions that will permit the TPC to complete the receive side of the money transfer, and, if the TPC is satisfied that printing of payment instruments has occurred without irregularity, to accept that these payment instruments will not be chargeable to the RTT (who, of as, course, did not receive the funds by which the customer initiated the associated money transfer transaction at the STT). Before proceeding, the computer 52 checks to confirm that the secure printer 54 is connected and has blank stock of payment instruments loaded and ready. After this check the employee 50 will cause computer 52 to transmit the recipient's name, or the send transaction reference number and/or other identifying information to the RTS 38 via the communication line 60b. Next, the RTS 38 searches the accounts payable file 40 for corresponding data such as the recipient's name or the send transaction reference number. If a corresponding open money transfer send transaction is found, the RTS 38 will confirm the transfer's existence to the computer 52 and the recipient's identity will be established by suitable identification means. If the identification check is satisfied, information about the amount of funds to be paid out is retrieved and analyzed to determine how the payout will be done. Information with the recipient's payout preferences will be part of this analysis.

How payout occurs depends on whether the RTT system 24 is attended by an employee or is an automated kiosk, such as an enhanced ATM device, and the facilities in each situation. If the RTT system 24 is attended by an employee, then there are three primary payout options:

1. The recipient is provided one money order for the full payout amount, which is cashed at the RTT.

2. The recipient is provided two money orders, together totaling the full payout amount. One may be cashed at the RTT and the other taken away by the recipient.

3. The recipient is provided any mix of cash and/or products by the RTT and receives no money order.

Options are similar at a kiosk, except that cash may dispensed directly, without a money order first being issued and then cashed, because it would make little sense to issue a money order and then take it back in for cashing. Also, cash and products can be dispensed for part of the payment with the balance in a money order.

In any event, the payout transactions of interest for the present invention use payment instruments, usually money orders payable to the recipient as payee. Assuming such a money order is to be issued, the amount must be determined, based on recipient preferences, available cash and other factors. When the amount of any money order has been determined and it is further determined whether it will be cashed or taken away by the recipient customer, instructions can be prepared for the secure printer 54. The instructions are transmitted and secure printer 54 receives instructions as to the money order(s) to be printed using the blank stock 70. The computer 52 monitors the printing and is capable of detecting certain irregularities.

Assuming a single money order is to be printed and payment instrument 70b is now the top of the blank stock 70, printing proceeds by filling in the amount fields 74b, 76b to create a money order. As an optional precaution, the serial number as tracked by the RTT system may be printed on the money order above the amount fields 74b, 76b, to allow comparison with the preprinted serial number in field 88b. The recipient's name appears in the payee field 72b, unlike a money order that is purchased. As an additional aid to identifying this payment instrument as part of a money transfer payout, use indicia field 87b can be marked with an alphanumeric code (e.g., “MG” for a MoneyGram”® transaction) to indicate this is a money transfer money order. Further use indicia field 89b can be marked with an alphanumeric code (e.g., “AG”) to indicated that the money order is for cashing by the trustee or with a different alphanumeric code (e.g., “CU”) to indicated that the money order is to be taken away by the a recipient customer. Once completely and properly printed, the money order 70b is dispensed by the secure printer 54. The employee 50 will then hand the money order 70b to the customer 32. If more than one money order is needed to complete the money transfer payout, then the printing process is repeated with the appropriate printing parameters for the other money orders, and all are handed to the customer 32 of the RTT.

Preferably the RTT system 24 transmits information about transaction completion in realtime after printing of a money transfer payment instrument with the issuer as drawer. This posting of transaction information to the issuer data processing system 21 is significant, because it provides RTS 38 with information for inhibiting any duplicate payment on the corresponding money transfer transaction and can be an agreed trigger for shifting responsibility between trustee and issuer. In particular, in one embodiment, the RTS 38 can be set up so that it must receive a satisfactory closing communication on the payout at the RTT system 24. To avoid certain possible forms of fraud in which the RTT or an RTT employee might participate, the TPC can arrange to shift responsibility from trustee to issuer (i.e., an instrument normally chargeable to the trustee becomes not chargeable to the trustee) only when RTS 38 receives from RTT system 24 a satisfactory closing communication confirming completion of printing and dispensing of the money order(s) used for a payout. Preferably this message includes the amount and serial number for each payment instrument printed to make a particular money transfer payout. This can be associated with the send side information recorded in the payables account 40 or elsewhere in the database for RTS 38. Thus, if the closing communication associated with any money transfer payment instrument to be printed does not reach RTS 38, the TPC cannot be sure that the recipient has been paid and cannot be sure that there will not be an attempt to collect a duplicate payout, and the TPC can contractually cause such a payment instrument to remain chargeable to the RTT that issued it. This provides the RTT with a strong incentive to avoid irregular or incomplete payout transactions.

The issuer may choose to “close” the transaction on its system before actually receiving information that the money transfer payment instrument has been properly printed and dispensed. This may be useful where communication lines are unreliable (e.g., certain dial-up connections) and the communication to RTS 38 may be broken off while waiting for the final confirmation of printing and dispensing. Thus, RTS 38 may use information received at the start of a money transfer payout communication exchange with the RTT system 24 to immediately “close” the transaction in the RTS database and prevent thereby any second attempt to get payout on the same money transfer. In this immediate close of the transaction the RTS 38 can provisionally record the RTT as relieved of responsibility for associated payment instruments issued, but then reverse this status if, following the immediate close, it appears that the RTS 38 does not receive the anticipated follow-up confirmation of successful printing and dispensing of the associated money transfer payment instruments. That is, the RTS 38 can separate the definition of closing of a money transfer transaction into two conditions: the accounting closing in the RTS 38 database and the “instrument dispensed” closing. The RTS 38 can establish appropriate definitions and protocols for closing communications to help limit its risk of double payment or acceptance of responsibility for a money transfer payment instrument that is in fact not properly dispensed.

The properly completed money transfer payment instrument 70b will eventually be used and deposited in a depository bank 26. The depository bank 26, using the Federal Reserve System, will present the money order to the clearing bank 28. The clearing bank 28 will debit the TPC's settlement account (most likely in some aggregate debit that includes a batch of payment instruments payable by the TPC, which debit the TPC will cover with a wire transfer or other payment to its settlement account). The TPC system 21 will capture or receive data communicating the presented money order's serial number 88b. This permits the TPC to use its database, including a file for tracking a stock of blank payment instruments provided to the RTT, to reconcile payment on that money order 70b with the closing communication and other transaction information recorded in the payables account file 40, received shortly after the money order 70b was printed from the RTT system 24 that issued it. The TPC may then use this information to reimburse the RTT operating RTT system 24 for the payout of funds advanced plus applicable fees.

The next following transaction handled by printer 54 may be either a money order sold or a money transfer payout. In either case the appropriate instrument can be printed using the blank stock payment instrument 70c and issued. The records in TPC system 21 can be updated to reflect whether this next instrument in the blank stock sequence remains chargeable to the trustee or becomes the TPC's responsibility as a payout for a TPC-based money transfer transaction.

D. RTS and Other Equipment

Referring again to FIG. 1, the RTS 38 can be any computer system capable of communicating with a plurality of STT and/or RTT trustees 22, 24 and capable of rapidly associating the communicated information with, and accessing and storing information in, records stored in an accounts payable file 40 and a plurality of trustee receivables files 42a, . . . 42n. In one embodiment, the RTS 38 comprises a “server” type computer system that communicates with the computers 46 and 52 via a modem bank (not shown) and telephone lines or similar links 60a, 60b. This embodiment is desirable because the modem lines are easily installable in a variety of locations and are relatively secure. However, other systems, such as computers connected to the internet, leased lines or a private network are within the scope of the present invention. This server computer system also includes database software of any suitable conventional kind.

The database software manages an accounts receivable file 42a, . . . 42n for each RTT operating an RTT system 24 and manages records in a payables account file 40 for the TPC operating TPC system 21. The payables account 40 in this embodiment comprises files and records that may contain the date and time that a money transfer was initiated, the recipient's identity, the transferred amount, and, eventually, the serial number 88 of the money transfer payment instrument(s) used in the receive transaction, as well as other receive side data useful in auditing the payout transaction. A receivables account 42a, . . . 42n in this embodiment similarly comprises computer records and data files containing the particular trustee's identity, the serial number ranges of the preprinted money orders delivered to that trustee, and amounts of all money orders sold, e.g., 70a, within that range of serial numbers, as well as the serial number of any payment instruments “adopted” by the TPC that operates TPC system 21 and thus not chargeable to the dispensing trustee, by reason of the payment instrument's use in a money transfer payout.

The secure printer 54 may be any device capable of maintaining physical security over the blank stock payment instruments 70 loaded in it, printing the correct information in the amount fields 74, 76, and cooperating with the computer 52 to indicate tampering, failed print H operations or other irregularities. One suitable secure printer is described in U.S. Pat. No. 4,625,275 to L. G. Smith, which is herein incorporated by reference. This secure printer can use the code mark printing validation method described in U.S. Pat. No. 4,699,532 to L. G. Smith, which is also herein incorporated by reference. These embodiments are desirable because the present invention may be easily adopted for use with existing secure printer equipment, which can reduce its initial cost of deployment.

Referring again to FIG. 2, each preprinted payment instrument includes a payee field 72, a numerical amount field 74, a written amount field 76, a routing number field 78, an account number field 80, use indicia fields 87, 89, a clearing bank identification field 84, an issuer/drawer identification field 86, and a preprinted serial number field 88. Certain fields are sized, shaped and positioned to comply with Federal Reserve System regulations regarding the processing of negotiable instruments, and certain identification information and legal statements may appear on the front and/or back, as is known to those skilled in the art. In this embodiment, the routing number field 78 and the account number field 80 both contain codes printed in a standard Magnetic Ink Character Recognition (MICR) font. Like most negotiable instruments, the routing number field 78 contains a code associated with the clearing bank 28. However, unlike standard checks, the account number field 80 contains the payment instrument's serial number. That is, the account number field 80 contains the same number as the serial number field 88. This feature allows the TPC system 21 to quickly acquire the serial numbers as part of item processing.

The information collected in the TPC system permits the system to provide to each trustee a statement for a specified time period showing which blank stock payment instruments have resulted in amounts chargeable to the trustee by the issuer and which have resulted in payment instruments not chargeable to the trustee by the issuer.

Although the present invention has been described in detail with reference to certain examples thereof, it may be also embodied in other specific forms without departing from the essential spirit or attributes thereof. For example, the electronic communication between computers 46, 52 and the RTS 38 could be replaced or supplemented by a manual or other systems. In these embodiments, employees 50 at the RTT that operates RTT system 24 would communicate the recipient's name to a corresponding employee at the TPC operating TPC system 21, who would reply with an authorization code. These embodiments may be desirable for use with low transaction volume trustees and with trustees in areas without reliable data communication services. In addition, although the computers 46, 52 and the printers 48, 52 have generally been described as separate units, embodiments in which their functions are performed by a single integrated machine are within the scope of the present invention. Similarly, the present invention may be integrated into other devices commonly used in retail stores, such as cash registers, lottery machines, automated teller machines, or the like.

Those skilled in the art will recognize equivalents exist for a variety of the computer components described herein and the invention is not limited to the embodiments described. In addition, any references to front and back, right and left, top and bottom and upper and lower, and the like are intended for convenience of description, not to limit the present invention or its components to any one positional or spatial orientation.

Therefore, it is desired that the embodiments described herein be considered in all respects as illustrative, not restrictive, and that reference be made to the appended claims for determining the scope of the invention.

We claim:

1. A method for dispensing a payment instrument through a trustee associated with the issuer of the payment instrument and accounting for such instrument, the method comprising:
arranging for the trustee to have a stock of blank payment instruments to be drawn against an issuer account, with individual instrument identification;
providing authorization to the trustee to dispense at least one completed payment instrument printed from the blank stock, whereby such payment instrument is associated with a customer transaction;
receiving from the trustee transaction information regarding the customer transaction associated with such payment instrument, including the value of such instrument and the individual instrument identification; and
determining from the transaction information whether or not the trustee is charged for the value of such payment instrument.

2. The method of claim 1, and further comprising the additional step of receiving an electronic request from the trustee for authorization to dispense such payment instrument.

3. The method of claim 1, and further comprising the additional step of providing a data processing system for tracking a plurality of customer transactions, at least one of said customer transactions being a money transfer.

4. The method of claim 3, wherein the step of providing authorization includes the additional steps of receiving transaction information transmitted from the trustee identifying a potential recipient of a payment instrument, determining if a money transfer transaction for the potential recipient exists, and, if so, transmitting to the trustee authorization for dispensing, and an amount for which, the payment instrument shall be issued.

5. The method of claim 4, and further comprising the additional step of determining successful completion of dispensing of the payment instrument and in response thereto inhibiting in the data processing system a duplicate payment of the money transfer to the potential recipient.

6. The method of claim 1, wherein the blank payment instruments include MICR encoding preprinted thereon.

7. The method of claim 1, and further comprising the additional step of providing a data processing system for tracking payment instruments whose value has been charged to the trustee and those whose value has not been charged to the trustee.

8. The method of claim 7, wherein the step of determining if the trustee is charged is performed by the data processing system, responsive to the transaction information from the trustee.

9. The method of claim 1, wherein the step of receiving transaction information regarding the transaction associated with the payment instrument includes the step of receiving a transmission from the trustee that confirms completed dispensing of a payment instrument.

10. A method for dispensing a payment instrument through a trustee associated with an issuer of the payment instrument, the method comprising;
receiving a blank payment instrument to be drawn against an issuer account;
storing in a secured printer the blank payment instrument;
receiving from a potential recipient a request for a payment instrument where the value of said payment instrument is not chargeable to the trustee;
requesting authorization from the issuer to dispense the requested payment instrument; and
with authorization from the issuer, causing the printer to dispense a payment instrument completed from the blank payment instrument.

11. The method of claim 10, wherein the step of requesting authorization includes the additional step of transmitting identifying information of the potential recipient to the issuer.

12. The method of claim 10, wherein the step of causing a printer to dispense a payment instrument includes instruction transmitted to a printer enabling it to print a payment instrument selected from the group consisting of a gift certificate, a money order, or a payroll check using the blank payment instrument.

13. The method of claim 10, wherein the blank payment instrument includes MICR encoding preprinted thereon.

14. The method of claim 10, and further comprising the additional step of transmitting a closing communication to the issuer confirming a money transfer transaction can be closed.

15. A method for printing and dispensing from a single secure printer operated by a trustee both payment instruments for money transfer transactions handled by an issuer and other payment instruments for which issuer will charge the trustee, comprising:
arranging for a single blank stock of payment instruments for the secure printer;
providing an issuer data processing system for tracking a plurality of money transfer transactions handled by the issuer and obligations charged by the issuer to the trustee,
whereby said transactions and obligations involve execution at the secure printer printing instructions for money transfer payment instruments and other payment instruments;
whereby in response to printing instructions for a payment instrument for which the issuer will charge the trustee, the secure printer prints from the single blank stock a payment instrument with the issuer as drawer and the payment instrument is recorded in the issuer data processing system as chargeable to the trustee; and
whereby in response to printing instructions for a money transfer payment on a corresponding money transfer transaction, the secure printer prints from the single blank stock a payment instrument with the issuer as drawer and the payment instrument is recorded in the issuer data processing system as an obligation of issuer, not chargeable to the trustee.

16. The method of claim 15 further comprising in real-time after completion of printing of a payment instrument for a money transfer payment with the issuer as drawer, receiving at the issuer data processing system information inhibiting any duplicate payment on the corresponding money transfer transaction.

17. The method of claim 15 wherein the secure printer completes on the blank stock a payment instrument comprising a money order.

18. The method of claim 15 wherein the secure printer completes on the blank stock a payment instrument comprising a payment instrument selected from the group consisting of a gift certificate, a vendor payment money order and a payroll check.

19. The method of claim 15 further comprising, providing to the trustee a statement for a specified time period showing which payment instruments dispensed by the trustee have resulted in amounts charged to trustee by issuer.

20. The method of claim 15 further comprising, providing to the trustee a statement for a specified time period showing which payment instruments dispensed by the trustee have resulted in amounts not charged to trustee.

21. The method of claim 15 wherein the act of arranging for a single blank stock of payment instruments comprises arranging for payment instruments printed with MICR indicia identifying issuer's clearing bank.

22. The method of claim 15 further comprising, checking for a closing communication in connection with the printing instructions for a money transfer payment instrument on a corresponding money transfer transaction and inhibiting recording the payment instrument in the issuer data processing system as an obligation of issuer, not chargeable to the trustee, until a closing communication is received at the issuer data processing system.

23. The method of claim 22, wherein the action of checking for a closing communication comprises checking for a communication that confirms correct printing of a payment instrument in response to printing instructions for a money transfer payment instrument.

24. The method of claim 22, wherein the action of checking for a closing communication comprises checking for a communication that supplies the serial number of a payment instrument printed in response to the printing instructions for a money transfer payment instrument.

25. A system for controlling on behalf of an issuer of payment instruments the printing and dispensing through a trustee of the issuer's payment instruments, said payment instruments implementing money transfer transactions handled by the issuer and other transactions for which issuer will charge the trustee, comprising
a data processing system;
a database supported by the data processing system for tracking a plurality of money transfer transactions handled by the issuer and obligations charged by the issuer to the trustee;
a computer code component for receiving information reporting on operations of a secure printer operated by the trustee with a blank stock of preprinted payment instruments payable by issuer, said secure printer adapted to print from the blank stock both money transfer payment instruments and other payment instruments;
a computer code component for processing received information regarding a first payment instrument for which issuer will charge the trustee and for recording the first payment instrument in the issuer data processing system as chargeable to the trustee; and
a computer code component for processing received information regarding a second, money transfer payment instrument on a corresponding money transfer transaction and for recording the second payment instrument in the issuer data processing system as an obligation of issuer, not chargeable to the trustee.

26. The system of claim 25 further comprising a computer code component for receiving at the data processing system in real time following printing of a money transfer payment instrument, information for inhibiting any duplicate payment on the corresponding money transfer transaction.

27. The system of claim 25 further comprising a computer code component for producing a statement for a specified time period showing which payment instruments dispensed by a trustee have resulted in amounts charged to the trustee by issuer.

28. The system of claim 25 further comprising a computer code component for producing a statement for a specified time period showing which payment instruments dispensed by a trustee have resulted in amounts not charged to the trustee.

29. The system of claim 25 further comprising, a computer code component for checking for a closing communication in connection with the printing of a money transfer payment instrument on a corresponding money transfer transaction and for inhibiting recording the payment instrument in the data processing system as an obligation of issuer not chargeable to the trustee until a closing communication is received at the data processing system.

30. The system of claim 29, wherein the computer code component for checking for a closing communication comprises a computer code component for checking for a communication that confirms correct printing of a payment instrument in response to the money transfer transaction.

31. The system of claim 29, wherein the computer code component for checking for a closing communication comprises a computer code component for checking for a communication that supplies the individual identification for a payment instrument printed in response to the money transfer transaction.

32. A computer program product comprising:
a computer usable medium and computer readable code embodied on said computer useable medium for controlling on behalf of an issuer of payment instruments the printing and dispensing through a trustee of the issuer's payment instruments, said payment instruments implementing money transfer transactions handled by the issuer and other transactions for which issuer will charge the trustee, comprising:
a computer code component for receiving information reporting on operations of a secure printer operated by the trustee with a blank stock of preprinted payment instruments payable by issuer, said secure printer adapted to print from the blank stock both money transfer payment instruments and other payment instruments;
a computer code component for processing received information regarding a first payment instrument for which issuer will charge the trustee and for recording the first payment instrument in a data processing system as chargeable to the trustee; and
a computer code component for processing received information regarding a second, money transfer payment instrument on a corresponding money transfer transaction and for recording the second payment instrument in the data processing system as an obligation of issuer, not chargeable to the trustee.

33. The program product of claim 32 further comprising a computer code component for receiving in real time following printing of a money transfer payment instrument, information for inhibiting any duplicate payment on the corresponding money transfer transaction.

34. The program product of claim 32 further comprising a computer code component for producing a statement for a specified time period showing which payment instruments dispensed by a trustee have resulted in amounts charged to the trustee by issuer.

35. The program product of claim 32 further comprising a computer code component for producing a statement for a specified time period showing which payment instruments dispensed by a trustee have resulted in amounts not charged to the trustee .

36. The program product of claim 32 further comprising, a computer code component for checking for a closing communication in connection with the printing of a money transfer payment instrument on a corresponding money transfer transaction and for inhibiting recording the payment instrument in the data processing system as an obligation of issuer not chargeable to the trustee until a closing communication is received at the data processing system.

37. The program product of claim 36, wherein the computer code component for checking for a closing communication comprises a computer code component for checking for a communication that confirms correct printing of a payment instrument in response to the money transfer transaction.

38. An apparatus for controlling on behalf of an issuer of payment instruments the printing and dispensing through a trustee of the issuer's payment instruments, said payment instruments implementing money transfer transactions handled by the issuer and other transactions for which issuer will charge the trustee, comprising
a secure printer associated with the trustee with a blank stock of preprinted payment instruments payable by issuer to print from the blank stock both money transfer payment instruments and other payment instruments;
a computer code component for sending to a database information reporting on operations of the secure printer for tracking a plurality of money transfer transactions handled by the issuer and obligations charged by the issuer to the trustee;
a computer code component communicating with the secure printer for processing information regarding a payment instrument for which issuer will charge the trustee and for recording the instrument in the database as chargeable to the trustee; and
a computer code component communicating with the secure printer for processing information regarding a money transfer payment instrument on a corresponding money transfer transaction and for recording the payment instrument in the database as an obligation of issuer, not chargeable to the trustee.

39. The apparatus of claim 38 further comprising a computer code component for communicating in real time following printing of a money transfer payment instrument, information for inhibiting any duplicate payment on the corresponding money transfer transaction.

40. The apparatus of claim 38 further comprising a computer code component for receiving a statement for a specified time period showing which payment instruments dispensed by a trustee have resulted in amounts charged to the trustee by issuer.

41. The apparatus of claim 38 further comprising a computer code component for receiving a statement for a specified time period showing which payment instruments dispensed by a trustee have resulted in amounts not charged to the trustee.

42. The system of claim 38 further comprising, a computer code component for checking for a closing communication in connection with the printing of a money transfer payment instrument on a corresponding money transfer transaction and for inhibiting recording the payment instrument in a data processing system of issuer as an obligation of issuer until a closing communication is received at the data processing system.

43. The apparatus of claim 42, wherein the computer code component for checking for a closing communication comprises a computer code component for checking for a communication that confirms correct printing of a payment instrument in response to the money transfer transaction.

44. A computer program product comprising:
a computer usable medium and computer readable code embodied on said computer useable medium for controlling on behalf of an issuer of payment instruments the printing and dispensing through a trustee of the issuer's payment instruments, said payment instruments implementing money transfer transactions handled by the issuer and other transactions for which issuer will charge the trustee, comprising
a computer code component for controlling a secure printer associated with the trustee with a blank stock of preprinted payment instruments payable by issuer, to print from the blank stock both money transfer payment instruments and other payment instruments;
a computer code component for sending to a database information reporting on operations of the secure printer for tracking a plurality of money transfer transactions handled by the issuer and obligations charged by the issuer to the trustee;
a computer code component communicating with the secure printer for processing information regarding a payment instrument for which issuer will charge the trustee and for recording the instrument in the database as chargeable to the trustee; and
a computer code component communicating with the secure printer for processing information regarding a money transfer payment instrument on a corresponding money transfer transaction and for recording the payment instrument in the database as an obligation of issuer, not chargeable to trustee.

45. A memory for storing data for access by a program being executed on a data processing system, said program for controlling on behalf of an issuer of payment instruments printing and dispensing through a trustee of the issuer's payment instruments, said payment instruments implementing money transfer transactions handled by the issuer and other transactions for which issuer will charge the trustee comprising:
a data structure stored in said memory, said data structure including information resident in a database used by said program and including:
a first file for tracking a stock of blank payment instruments to be drawn against an issuer account, with individual instrument identification;
a second file for tracking a plurality of payment instrument purchases, said file including:
the amount of each payment instrument dispensed,
an indicator of whether or not said dispensed payment instrument has been presented for payment by issuer,
the amount of funds the trustee dispensing the dispensed payment instrument has been charged for such payment instrument;
and the amount of fees associated with the dispensing of said instrument; and
a third file for tracking a plurality of money transfer transactions, said file including for each money transfer transaction:
identifying information for the recipient of the money transfer,
the amount of money to be transferred,
an indicator of whether or not a payment instrument or other form of payment has been dispensed to the recipient, and
if a payment instrument has been dispensed to the recipient, the individual instrument identification for such payment instrument and an indicator that the issuing trustee is not chargeable for the amount of the payment instrument.

46. A method for printing completed payment instruments for an issuer of such instruments for use as money orders or the like and for money transfer, comprising:
receiving a common blank payment instrument supply for payment instruments drawn by issuer, with individual instrument identification;
receiving a customer transaction request for purchase of an instrument for use as a money order or the like or for issuance of a payment instrument as payout of a money transfer:
in response to the request for purchase of an instrument for use as a money order or the like:
receiving payment from the customer;
printing value indicia on a first payment instrument from the blank stock;
reporting the individual identifier associated with the first payment instrument to a transaction processor for the issuer; and
accounting for a credit to the issuer in the amount of the first payment instrument; and
in response to the request for issuance of a payment instrument as payout of a money transfer:
receiving identifying information from the customer;
querying the transaction processor for a transferred amount;
printing value indicia on a second payment instrument; and
reporting the individual identifier associated with the second payment instrument to the transaction processor.

47. The method of claim 46, wherein the response to the money transfer transaction further comprises:
providing the second payment instrument to the customer for endorsement;
receiving the second payment instrument with endorsement from the customer; and
providing cash or other consideration to the customer.

48. The method of claim 46, wherein the payment instrument is chosen from the group consisting of a money order, a draft, a gift certificate, and a check.
